(19) United States
(12) Patent Application Publication
(10) Pub. No.: US 2025/0293422 A1
(43) Pub. Date: Sep. 18, 2025

(54) RESONATOR AND WAVEGUIDE CIRCUIT INCLUDING THE SAME

(71) Applicant: NEC Corporation, Tokyo (JP)

(72) Inventor: Keiichi MOTOI, Tokyo (JP)

(73) Assignee: NEC Corporation, Tokyo (JP)

(21) Appl. No.: 19/055,612

(22) Filed: Feb. 18, 2025

(30) Foreign Application Priority Data
Mar. 18, 2024 (JP) 2024-042426

(51) Int. Cl. H01P 7/10; H01P 3/16; H01Q 1/38

(52) U.S. Cl. CPC H01P 7/10; H01P 3/16; H01Q 1/38

(57) ABSTRACT

A resonator according to the present disclosure includes: a dielectric; conductor plates provided so as to enclose the dielectric; and a plurality of flat and conductive patches arranged inside the dielectric along a bottom surface of the conductor plates.

### INCORPORATION BY REFERENCE

This application is based upon and claims the benefit of priority from Japanese patent application No. 2024-042426, filed on Mar. 18, 2024, the disclosure of which is incorporated herein in its entirety by reference.

### TECHNICAL FIELD

The present disclosure relates to a resonator and a waveguide circuit including the same.

### BACKGROUND ART

In accordance with a demand that the size of a radio communication apparatus be reduced, it has been required to reduce the size of a waveguide circuit such as a filter circuit mounted on the radio communication apparatus. Further, in order to reduce the size of the waveguide circuit, it has been required to reduce the size of a resonator used in the waveguide circuit. One of techniques regarding the radio communication apparatus is disclosed, for example, in Patent Literature 1.
[Patent Literature 1] Japanese Unexamined Patent Application Publication No. 2016-007059

### SUMMARY

While Patent Literature 1 discloses reduction in changes in antenna characteristics, it does not disclose reduction in the size of a resonator structure. Therefore, there is a problem in Patent Literature 1 that it is difficult to reduce the size of a resonator and the size of a waveguide circuit such as a filter circuit including the resonator.

An object of the present disclosure is to provide a resonator and a waveguide circuit including the same that solve the aforementioned problem.

A resonator according to the present disclosure includes: a dielectric; conductor plates provided so as to enclose the dielectric; and a plurality of flat and conductive patches arranged inside the dielectric along a bottom surface of the conductor plates.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a schematic perspective and cross-sectional view showing a configuration example of a first resonator according to the present disclosure;

FIG. 2 is a schematic perspective and cross-sectional view showing a configuration example of a resonator according to a comparative example;

FIG. 3 shows an overview of magnetic field distribution of each of the lowest-order TE110 mode of an eigenmode, and a secondary higher-order TE210/TE120 mode in the resonator according to the comparative example;

FIG. 4 shows a calculation example of a resonance frequency of each mode in the resonator according to the comparative example;

FIG. 5 is a schematic cross-sectional view showing a more detailed configuration example of the first resonator according to the present disclosure;

FIG. 6 shows results of an electromagnetic field simulation of a resonance frequency of each mode in the first resonator according to the present disclosure;

FIG. 7 shows results of an electromagnetic field simulation of a resonance frequency of each mode in the first resonator according to the present disclosure;

FIG. 8 is a schematic perspective and cross-sectional view showing a first modified example of the first resonator according to the present disclosure;

FIG. 9 is a schematic perspective and cross-sectional view showing a second modified example of the first resonator according to the present disclosure;

FIG. 10 is a schematic perspective and cross-sectional view showing a third modified example of the first resonator according to the present disclosure;

FIG. 11 is a schematic perspective and cross-sectional view showing a configuration example of a second resonator according to the present disclosure;

FIG. 12 is a schematic perspective and cross-sectional view showing a configuration example of a third resonator according to the present disclosure;

FIG. 13 is a schematic perspective and cross-sectional view showing a configuration example of the third resonator according to the present disclosure;

FIG. 14 is a schematic perspective view showing a configuration example of a first BPF on which a resonator according to the present disclosure is mounted;

FIG. 15 is a schematic perspective view showing a configuration example of a BPF on which a resonator according to the comparative example is mounted;

FIG. 16 shows results of an electromagnetic field simulation of transmission characteristics between ports P2 and P1 of a first BPF according to the present disclosure;

FIG. 17 is a schematic perspective view showing a configuration example of a second BPF according to the present disclosure;

FIG. 18 is a schematic cross-sectional view showing a configuration example of the second BPF according to the present disclosure;

FIG. 19 is a schematic cross-sectional view in which a part of the second BPF according to the present disclosure is enlarged;

FIG. 20 shows results of an electromagnetic field simulation of transmission characteristics between ports P2 and P1 of the second BPF according to the present disclosure;

FIG. 21 shows results of an electromagnetic field simulation of transmission characteristics of ports P4 and P3 of the second BPF according to the present disclosure;

FIG. 22 shows results of an electromagnetic field simulation of electric field intensities at time of input and output in ports P2 and P1 of a BPF according to the comparative example;

FIG. 23 shows results of an electromagnetic field simulation of electric field intensities at time of input and output in the ports P2 and P1 of the second BPF according to the present disclosure;

FIG. 24 shows results of an electromagnetic field simulation of electric field intensities at time of input and output in ports P4 and P3 of the BPF according to the comparative example;

FIG. 25 shows results of an electromagnetic field simulation of electric field intensities at time of input and output in the ports P4 and P3 of the second BPF according to the present disclosure;

FIG. 26 is a schematic perspective view showing a configuration example of a third BPF according to the present disclosure; and

FIG. 27 shows results of an electromagnetic field simulation of transmission characteristics between ports P4 and P3 of the third BPF according to the present disclosure.

### EMBODIMENTS

Example embodiments of the present disclosure will be described below with reference to the accompanying drawings. Note that the drawings are in simplified form and the technical scope of the example embodiments should not be narrowly interpreted to be limited to the drawings. The same elements are denoted by the same reference numerals and a duplicate description is omitted.

In the following example embodiments, when necessary, the present disclosure is explained by using separate sections or separate example embodiments. However, those example embodiments are not unrelated with each other, unless otherwise specified. That is, they are related in such a manner that one example embodiment is a modified example, an application example, a detailed example, or a supplementary example of a part or the whole of another example embodiment. Further, in the following example embodiments, when the number of elements or the like (including numbers, values, quantities, ranges, and the like) is mentioned, the number is not limited to that specific number except for cases where the number is explicitly specified or the number is obviously limited to a specific number based on its principle. That is, a larger number or a smaller number than the specific number may also be used.

Further, in the following example embodiments, the components (including operation steps and the like) are not necessarily indispensable except for cases where the component is explicitly specified or the component is obviously indispensable based on its principle. Similarly, in the following example embodiments, when a shape, a position relation, or the like of a component(s) or the like is mentioned, shapes or the like that are substantially similar to or resemble that shape are also included in that shape except for cases where it is explicitly specified or they are eliminated based on its principle. This is also true for the above-described number or the like (including numbers, values, quantities, ranges, and the like).

### <Study in Advance>

The rapid spread of radio communication has led to a problem that there is a shortage in frequency bands used for radio communication. One of techniques for effectively using a frequency band is beamforming. Beamforming is a technique capable of achieving radio communication with a predetermined communication target by radiating radio waves having directivity, and is a technique in which interference with other radio systems is prevented while signal quality is maintained.

A typical technique for achieving beamforming is phased array. Phased array is a technique for enhancing a signal in a desired direction by adjusting the phases of radio signals fed to a plurality of antenna elements in a transmitter and combining radio waves radiated from each antenna element in space. In recent years, an integral-type module in which a planar antenna such as a patch antenna and a high-frequency unit of a transceiver are mounted on each of both sides of a substrate has been receiving attention in terms of reducing the size of an antenna module. It is desired that a plurality of antenna elements in the phased array be disposed at intervals of about a half wavelength of a carrier wave. Therefore, as the frequency becomes higher, the intervals between the antennas become shorter. Consequently, the size of the above-described integral-type module may become small. Giving a millimeter-wave band as an example, the half wavelength is 5 mm at 30 GHz (a wavelength of 10 mm), and the half wavelength is 2.5 mm at 60 GHz band (a wavelength of 5 mm). It is necessary to mount a transmission and reception unit in these about half-wavelength regions in order to implement an integral-type module, and accordingly it is desired to integrate a plurality of transceivers including a phase shifter. Polarization diversity and polarization multiple-input and multiple-output (MIMO) that use two types of orthogonal polarized waves may be used in order to improve communication quality. When two types of polarized waves are generated simultaneously by one antenna element, two transmission and reception units are respectively connected to feeding points disposed at positions different from each other in the one antenna element.

Further, in order to prevent interference with other communication systems or radio observation, it is required that a filter that suppresses unwanted radiation be provided in the integral-type module. However, as described above, filters for the millimeter wave band need to be implemented in a restricted area of the integral-type module. That is, it is required to reduce the size of a waveguide circuit such as a filter circuit and that of a resonator used for the waveguide circuit.

In view of the above circumstances, a resonator and a waveguide circuit including the same according to the present disclosure capable of achieving reduction in size are provided.

### First Example Embodiment

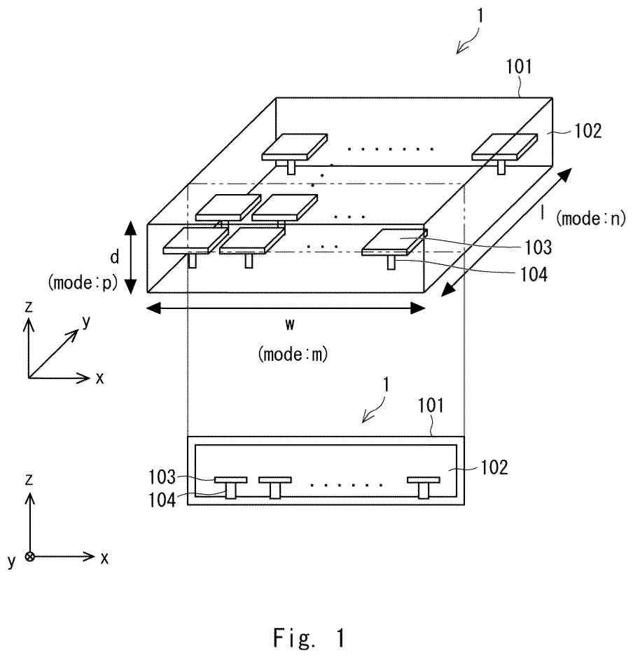

FIG. 1 is a schematic perspective and cross-sectional view showing a configuration example of a first resonator according to the present disclosure. As shown in FIG. 1, a resonator 1 includes a rectangular resonator (a resonator having a rectangular parallelepiped shape). Specifically, the resonator 1 includes conductor plates (i.e., walls or sheets) 101, a dielectric 102, a plurality of patches 103, and a plurality of vias 104.

The conductor plates 101, which are conductors made of metal or the like, are provided so as to enclose the dielectric 102. The dielectric 102 may include gases such as air. The conductor plates 101 define an outer shape of the resonator 1. While the conductor plates 101 form a cuboid shape in the example shown in FIG. 1, this is merely one example, and the conductor plates 101 may form, for example, a cylindrical or polygonal columnar shape.

The plurality of patches 103 are flat conductors made of metal or the like, and are arranged in a matrix inside the dielectric 102 along a bottom surface (xy plane) of the conductor plates 101. While each patch 103 has a square planar shape in the example shown in FIG. 1, this is merely one example, and each patch 103 may have a rectangular (other than square), polygonal, or circular planar shape.

The plurality of vias 104 are conductors made of metal or the like, and are provided inside the dielectric 102 in such a way that they extend from the bottom surface of the conductor plates 101 to the plurality of respective patches 103. One of the ends of each one of the plurality of the vias 104 is connected to a central part of the main surface of each of the plurality of the flat patches 103. As a result, each pair of one of the patches 103 and one of the vias 104 has a mushroom-shaped outer shape.

That is, the conductor plates 101 contain not only the dielectric 102 but also a metamaterial structure composed of a plurality of patches 103 and a plurality of vias 104. Each of the patches 103 is formed in such a way that its size is equal to or smaller than a fraction (e.g., one half, one third, or one fifth) of a wavelength corresponding to a resonance frequency of the resonator 1. More specifically, each of the patches 103 is formed in such a way that a long side of a rectangular planar shape becomes equal to or smaller than a fraction of the wavelength corresponding to the resonance frequency of the resonator 1. Even more specifically, each of the patches 103 is formed in such a way that (e.g., the long side of the rectangular planar shape) becomes equal to or smaller than one tenth of the wavelength corresponding to the resonance frequency of the resonator 1.

### (Comparison Between Resonator 1 According to the Present Disclosure and Resonator 50 According to Comparative Example)

Next, results of comparing the resonator 1 with a resonator 50 according to a comparative example will be described.

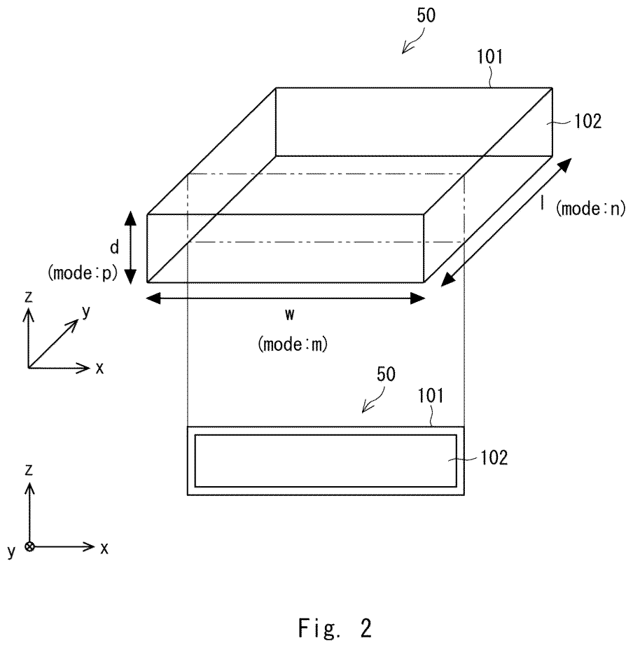

FIG. 2 is a schematic perspective and cross-sectional view showing a configuration example of a resonator 50 according to a comparative example. As shown in FIG. 2, the resonator 50 is different from the resonator 1 in that the resonator 50 does not include a plurality of patches 103 and a plurality of vias 104. In other words, the resonator 50 does not contain a metamaterial structure composed of a plurality of patches 103 and a plurality of vias 104 in conductor plates 101. Since the other configurations of the resonator 50 are the same as those of the resonator 1, the descriptions thereof will be omitted.

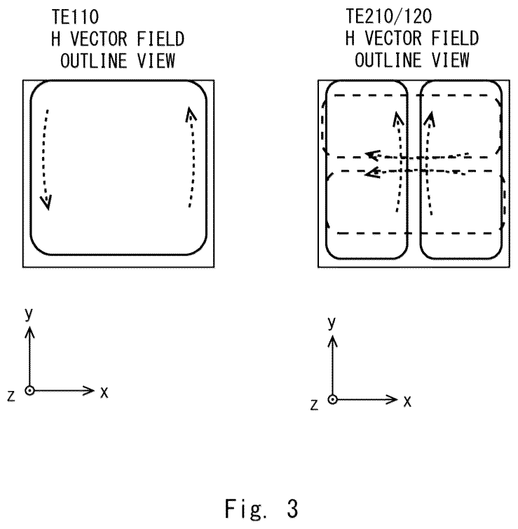

FIG. 3 shows an overview of magnetic field distribution of each of the lowest-order TE110 mode of an eigenmode, and a secondary higher-order TE210/TE120 mode in the resonator 50 according to the comparative example.

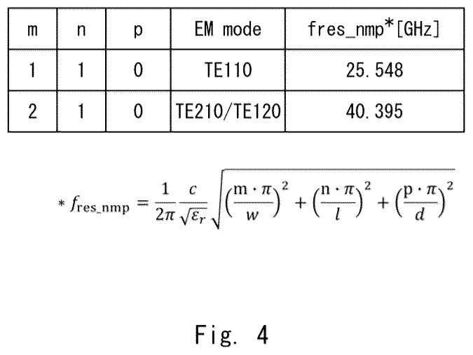

FIG. 4 shows a calculation example of a resonance frequency of each mode in the resonator 50 according to the comparative example. In the example shown in FIG. 4, the horizontal width (the length in the x-axis direction) w of the resonator 50 is 4.5 mm, the vertical width (the length in the y-axis direction) 1 of the resonator 50 is 4.5 mm, and the thickness (the length in the z-axis direction) d of the resonator 50 is 0.2 mm. Further, in the example shown in FIG. 4, the dielectric constant εr of the dielectric 102 provided in the resonator 50 is 3.4. In this case, the resonance frequency of the TE110 mode of the resonator 50 shows 25.548 GHz, and the resonance frequency of the TE210/TE120 mode shows 40.395 GHz. Therefore, a degree of freedom in the design of the resonator 50 is low, and in order to reduce the size thereof, a high dielectric constant substrate or the like such as a ceramic material needs to be used, which causes the cost to be increased compared to a case in which a general printed circuit board with a relatively small dielectric constant is used.

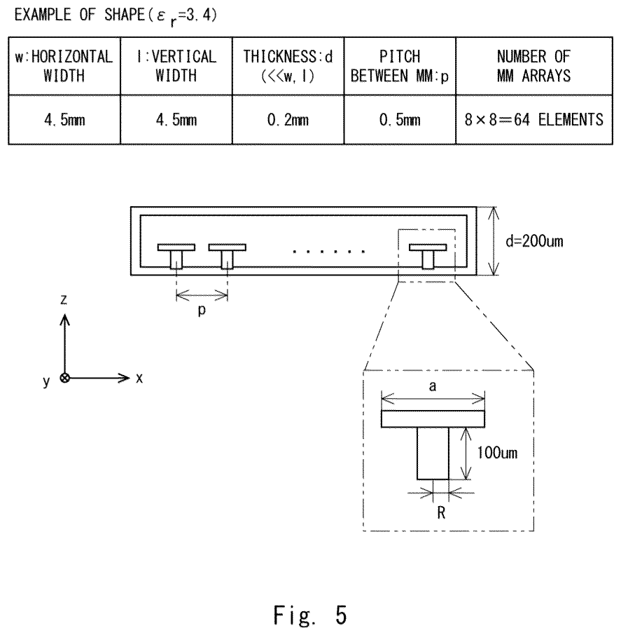

FIG. 5 is a schematic cross-sectional view showing a more detailed configuration example of the resonator 1 according to the present disclosure. In the example shown in FIG. 5, the horizontal width (the length in the x-axis direction) w of the resonator 1 is 4.5 mm, the vertical width (the length in the y-axis direction) 1 of the resonator 1 is 4.5 mm, and the thickness (the length in the z-axis direction) d of the resonator 1 is 0.2 mm. Further, in the example shown in FIG. 5, the dielectric constant εr of the dielectric 102 provided in the resonator 1 is 3.4. Further, in the example shown in FIG. 5, 64 patches 103 of 8 rows×8 columns are arranged in a matrix in the resonator 1 at an interval of 0.5 mm. “MM” in FIG. 5 is an abbreviation for a metamaterial (patches and vias). Further, “w/o MM” in the drawings represents a resonator 50 in which a metamaterial is not contained, “w/MM” in the drawings represents a resonator 1 in which a metamaterial is contained. Further, “R” in the drawings represents the radius of each of the vias 104 and “a” in the drawings represents the size (the length of one side) of each of the patches 103. The length of each of the vias 104 is 0.1 mm.

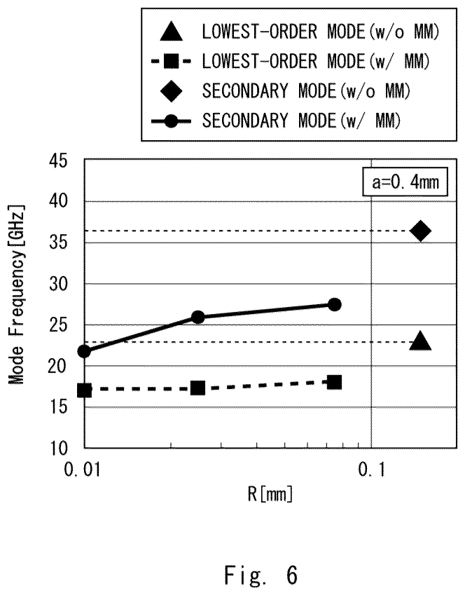

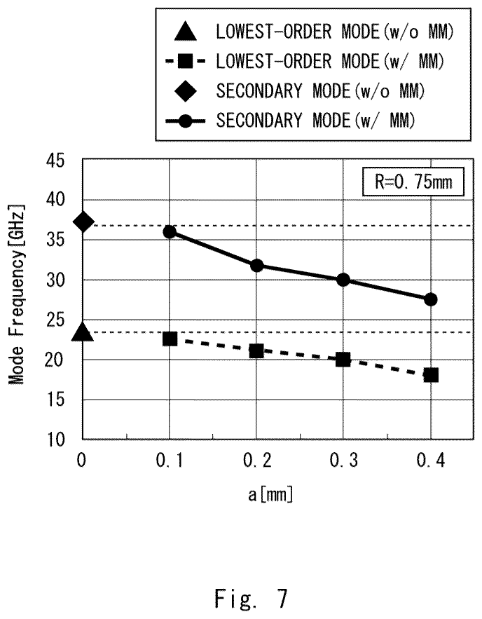

FIGS. 6 and 7 show results of electromagnetic field simulations of a resonance frequency of each mode in the resonator 1 in FIG. 5. More specifically, FIG. 6 shows a resonance frequency of each mode of the resonator 1 in a case where the radius R of each of the vias 104 is changed in a state in which the size a of each patch 103 is fixed to 0.4 mm. FIG. 7 shows a resonance frequency of each mode of the resonator 1 in a case where the size a of each patch 103 is changed in a state in which the radius R of each of the vias 104 is fixed to 0.75 mm. FIGS. 6 and 7 also show results of electromagnetic field simulations of a resonance frequency of each mode in the resonator 50 according to the comparative example.

First, as shown in FIG. 6, the resonance frequency of each mode in the resonator 1 is lower than that of the resonator 50 regardless of the size of the radius R of each of the vias 104. However, the smaller the radius R of each of the vias 104 is, the lower the resonance frequency of each mode is.

Further, as shown in FIG. 7, the resonator 1 is different from the resonator 50 in that the resonance frequency of each mode is lower regardless of the size a of each patch 103. However, the larger the size a of each patch 103 is, the lower the resonance frequency of each mode is.

As described above, the resonator 1 contains a metamaterial structure composed of a plurality of patches 103 and a plurality of vias 104, whereby it is possible to reduce the resonance frequency of each mode compared to a case where a resonator does not contain a metamaterial structure. Therefore, the resonator 1 can achieve a resonance frequency equivalent to that of the resonator 50 with a size smaller than that of the resonator 50. That is, it can be interpreted that the effective dielectric constant in the resonator 1 is larger due to the presence of the metamaterial structure.

### <First Modified Example of Resonator 1>

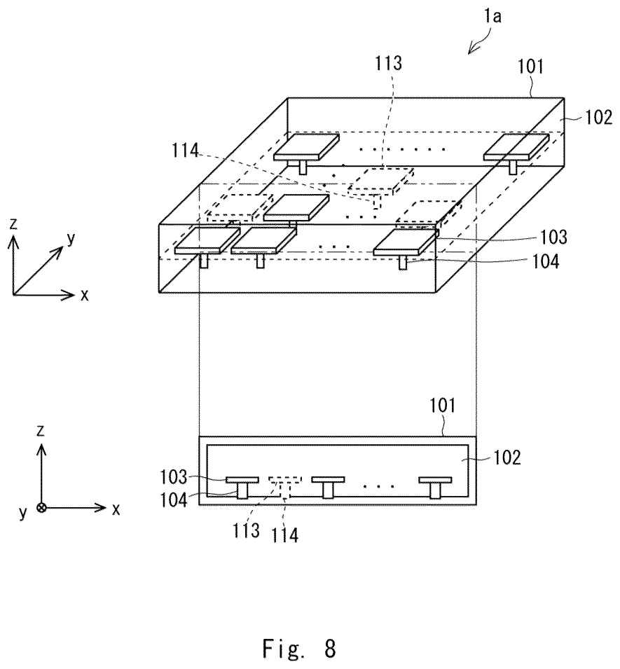

FIG. 8 is a schematic perspective and cross-sectional view showing a first modified example of the resonator 1 as a resonator 1a. The resonator 1a is different from the resonator 1 in that some of the plurality of patches 103 and the plurality of vias 104 contained in the conductor plates 101 are thinned out. In other words, in the resonator 1a, a plurality of patches 103 and a plurality of vias 104 that are partially thinned out are arranged in a matrix inside the dielectric 102 along a bottom surface of the conductor plates 101. Since the other configurations of the resonator 1a are the same as those of the resonator 1, the descriptions thereof will be omitted.

Patches 103 and vias 104 are respectively arranged in a formable area 113 of the plurality of patches 103 and a formable area 114 of the plurality of vias 104 in the resonator 1, whereas some of the plurality of patches 103 and some of the plurality of vias 104 are not arranged in a formable area 113 of these patches 103 and a formable area 114 of these vias 104 in the resonator 1a, as shown in FIG. 8.

In a case where, for example, it is possible that circuit characteristics may be degraded if a filter circuit (waveguide circuit) is formed by coupling a plurality of resonators 1a together, some of the patches 103 and vias 104 may be thinned out and resonator characteristics and electromagnetic coupling characteristics may be adjusted in the resonator 1a, whereby it is possible to prevent circuit characteristics from being degraded.

### <Second Modified Example of Resonator 1>

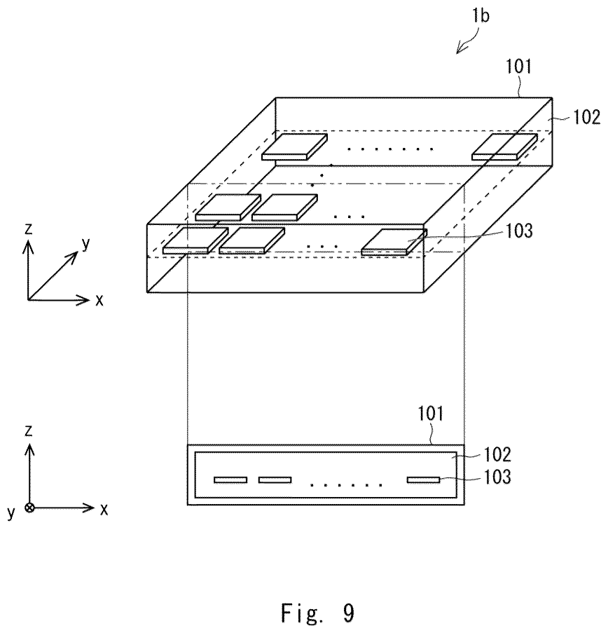

FIG. 9 is a schematic perspective and cross-sectional view showing a second modified example of the resonator 1 as a resonator 1b. The resonator 1b is different from the resonator 1 in that the resonator 1b does not include a plurality of vias 104. That is, in the resonator 1b, of the plurality of patches 103 and the plurality of vias 104, only the plurality of patches 103 are arranged in a matrix inside the dielectric 102 along the bottom surface of the conductor plates 101. Since the other configurations of the resonator 1b are the same as those of the resonator 1, the descriptions thereof will be omitted. The resonator 1b can achieve effects similar to those in the resonator 1.

### <Third Modified Example of Resonator 1>

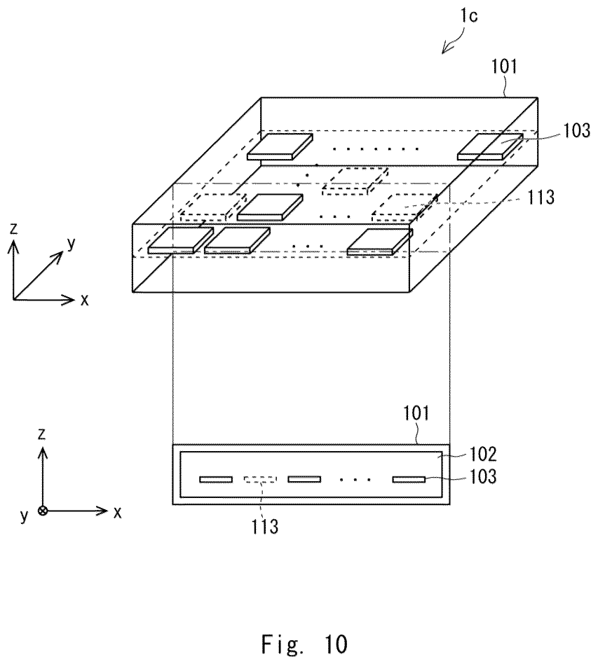

FIG. 10 is a schematic perspective and cross-sectional view showing a third modified example of the resonator 1 as a resonator 1c. Like the resonator 1b, the resonator 1c does not include a plurality of vias 104. That is, in the resonator 1c, of the plurality of patches 103 and the plurality of vias 104, only the plurality of patches 103 are arranged inside the dielectric 102 along the bottom surface of the conductor plates 101. Further, in the resonator 1c, like the resonator 1a, some of the plurality of patches 103 contained in the conductor plates 101 are thinned out. In other words, in the resonator 1c, a plurality of patches 103 are arranged in a matrix inside the dielectric 102 along the bottom surface of the conductor plates 101 in a state in which the plurality of patches 103 are partially thinned out. Since the other configurations of the resonator 1c are the same as those of the resonator 1, the descriptions thereof will be omitted.

The resonator 1c can achieve effects similar to those in the resonator 1. Further, in a case where it is possible that circuit characteristics may be degraded when a filter circuit (waveguide circuit) is formed by coupling a plurality of resonators 1c together, some of the patches 103 may be thinned out and resonator characteristics and electromagnetic coupling characteristics may be adjusted in the resonator 1c, whereby it may be possible to prevent circuit characteristics from being degraded.

### Second Example Embodiment

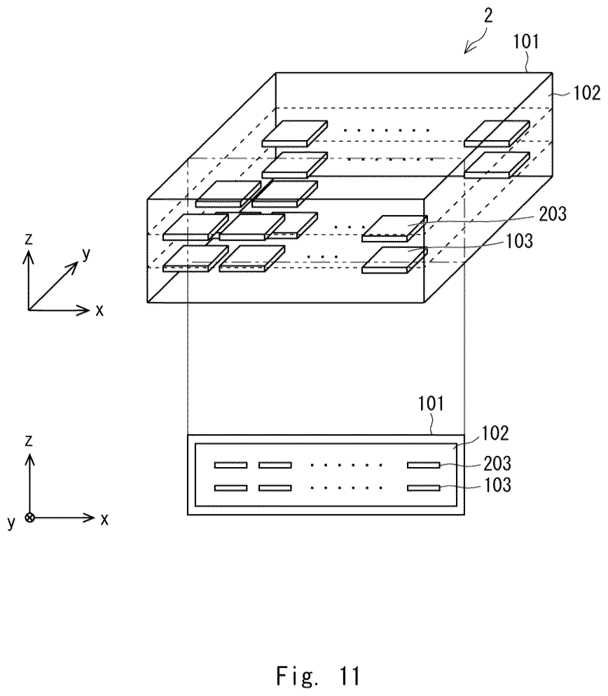

FIG. 11 is a schematic perspective and cross-sectional view showing a configuration example of a second resonator according to the present disclosure. As shown in FIG. 11, a resonator 2 according to the present disclosure is different from the resonator 1b described above in that the resonator 2 further includes a plurality of patches 203 in addition to the plurality of patches 103 provided in the resonator 1b. In the resonator 2, the plurality of patches 203 are laminated on the plurality of respective patches 103 inside the dielectric 102. Since the other configurations of the resonator 2 are the same as those of the resonator 1, the descriptions thereof will be omitted.

The resonator 2 contains a metamaterial structure of multiple layers, whereby it is possible to further reduce the resonance frequency of each mode. Therefore, the resonator 2 can achieve a resonance frequency equivalent to that of the resonator 50 with a size smaller than that of the resonator 1. In the resonator 2, some of the plurality of patches 103 may be thinned out or some of the plurality of patches 203 may be thinned out. While the example in which the resonator 2 contains a metamaterial structure of two layers has been described in this example embodiment, this is merely one example, and the resonator 2 may contain a metamaterial structure of three or more layers.

### Third Example Embodiment

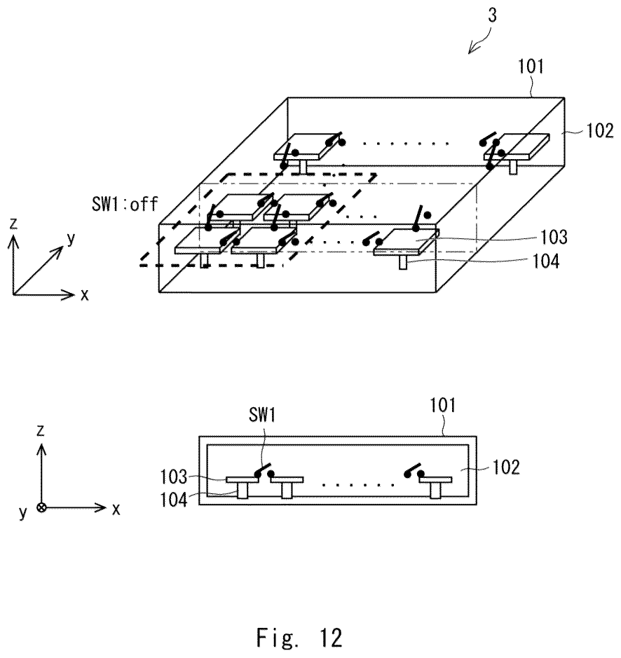

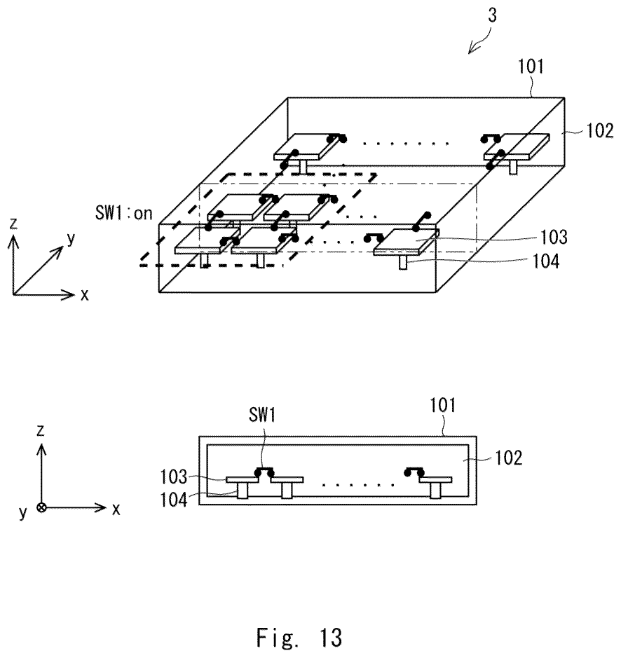

FIGS. 12 and 13 are each a schematic perspective and cross-sectional view showing a configuration example of a third resonator according to the present disclosure. As shown in FIGS. 12 and 13, a resonator 3 according to the present disclosure is different from the resonator 1 in that the resonator 3 further includes a plurality of switches SW1, each of which provided between a plurality of patches 103. Since the other configurations of the resonator 3 are the same as those of the resonator 1, the descriptions thereof will be omitted.

In the example shown in FIG. 12, all the plurality of switches SW1 are controlled to be OFF, whereby the plurality of patches 103 are electrically independent from each other. That is, in the example shown in FIG. 12, the resonator 3 is substantially equivalent to the resonator 1. On the other hand, in the example shown in FIG. 13, some of the plurality of switches SW1 are controlled to be ON, whereby a plurality of patches 103 are electrically connected to each other for every four patches 103 of 2 rows×2 columns.

The resonator 3 may control ON and OFF of the plurality of switches SW1 and change characteristics of the metamaterial structure, thereby controlling the resonance frequency. Therefore, for example, a filter circuit on which the resonator 3 is mounted is able to adjust frequency characteristics such as a passband.

In the example shown in FIG. 13, some of the plurality of switches SW1 are controlled to be ON, whereby a plurality of patches 103 are electrically connected to each other for every four patches 103 of 2 rows×2 columns. However, this is merely one example. In the resonator 3, some or all of the plurality of switches SW1 may be controlled to be ON, whereby the plurality of patches 103 may be electrically connected to each other for every arbitrary number of patches 103.

### Fourth Example Embodiment

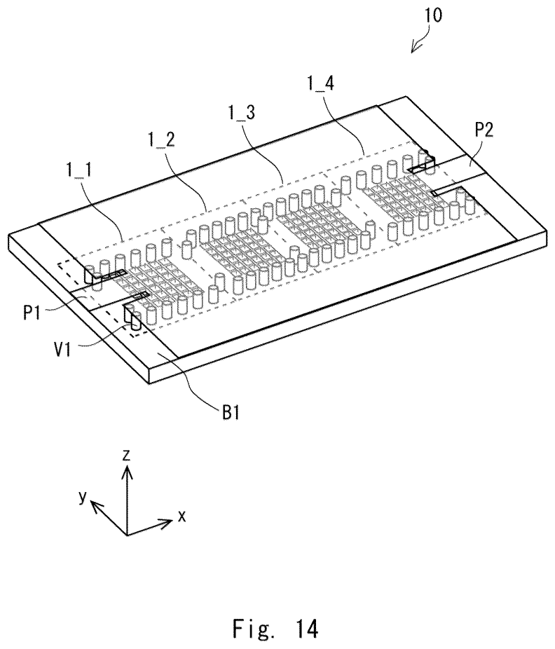

FIG. 14 is a schematic perspective view showing a configuration example of a first bandpass filter (BPF) on which the resonator according to the present disclosure is mounted. As shown in FIG. 14, a BPF 10 according to the present disclosure is a bandpass filter of a Substrate Integrated Waveguide (SIW) type, which waveguide is a kind of waveguide circuit, and the BPF 10 includes a plurality of resonators 1 arranged adjacent to each other inside a substrate B1. In the example shown in FIG. 14, the BPF 10 includes four resonators 1 (hereinafter these resonators 1 will also be referred to as resonators 1_1 to 1_4) arranged adjacent to each other inside the substrate B1.

Conductor plates 101 of each of the resonators 1_1 to 1_4 are composed of conductors formed on a lower surface and an upper surface of the substrate B1, and a plurality of metal-plated vias V1 connecting the conductors formed on the lower surface and the upper surface of the substrate B1. The lower surface of the substrate B1, which is a surface supporting the metamaterial structure, is a rear surface of the substrate B1. The upper surface of the substrate B1, which is a surface that covers the upper side of the metamaterial structure, is a front surface of the substrate B1. Further, the plurality of metal-plated vias V1 are provided to surround the side surfaces of the metamaterial structure. Among the conductor plates of each of the resonators 1_1 to 1_4, a conductor plate corresponding to a coupling part coupling to another resonator adjacent thereto is removed. Further, ports P1 and P2 are respectively provided in the resonators 1_1 and 1_4 which, among the resonators 1_1 to 1_4, are the ones provided on both ends of the BPF 10. The ports P1 and P2 are integrally formed with, for example, the upper surface of the substrate B1.

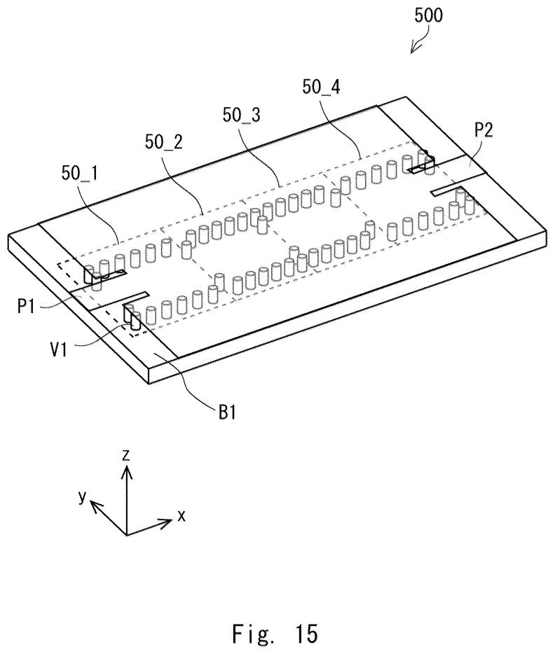

FIG. 15 is a schematic perspective view showing a configuration example of a BPF on which the resonator according to the comparative example is mounted. As shown in FIG. 15, a BPF 500 according to the comparative example, which is a SIW-type bandpass filter, includes four resonators 50 (hereinafter these resonators 50 will also be referred to as resonators 50_1 to 50_4) arranged adjacent to each other on a substrate B1. Conductor plates 101 of each of the resonators 50_1 to 50_4 are composed of conductors formed on a lower surface and an upper surface of the substrate B1, and a plurality of metal-plated vias V1 connecting the conductors formed on the lower surface and the upper surface of the substrate B1. Of the conductor plates 101 of each of the resonators 50_1 to 50_4, a conductor plate corresponding to a coupling part coupling to another resonator adjacent thereto is removed. Further, ports P1 and P2 are respectively provided in the resonators 50_1 and 50_4 which, among the resonator 50_1 to 50_4, are the ones provided on both ends of the BPF 500. For example, the ports P1 and P2 are integrally formed with the upper surface of the substrate B1.

That is, the BPF 10 according to the present disclosure is composed of a plurality of resonators 1 that contain a metamaterial structure, whereas the BPF 500 according to the comparative example is composed of a plurality of resonators 50 that do not contain the metamaterial structure.

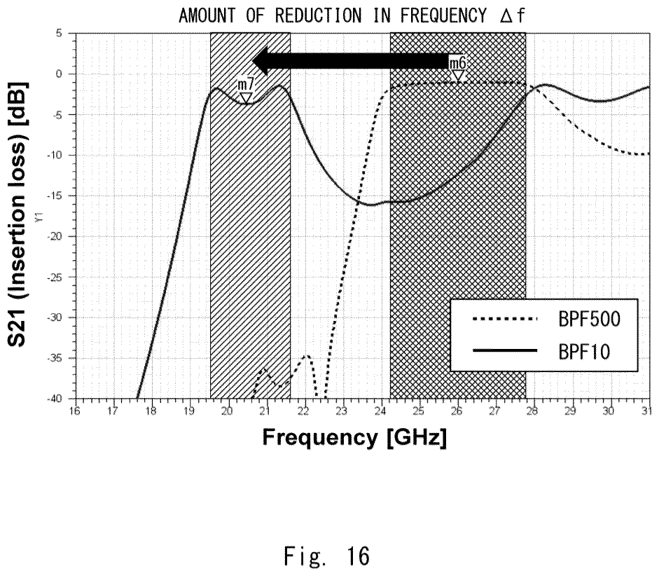

FIG. 16 shows results of an electromagnetic field simulation of transmission characteristics between the ports P2 and P1 of the first BPF according to the present disclosure. FIG. 16 shows not only results of an electromagnetic field simulation of transmission characteristics between the ports P2 and P1 of the BPF 10 but also results of an electromagnetic field simulation of transmission characteristics between the ports P2 and P1 of the BPF 500 according to the comparative example.

As shown in FIG. 16, the central frequency of the passband of the BPF 500 according to the comparative example is 26 GHZ, whereas the central frequency of the passband of the BPF 10 according to the present disclosure is reduced to 20.5 GHZ. Therefore, the BPF 10 according to the present disclosure can achieve a passband equivalent to that of the BPF 500 according to the comparative example with a size smaller than that of the BPF 500 to the extent of a percentage of the change in the frequency. Specifically, the size of the BPF 10 can be ideally reduced to about 78.8% (=20.5/26×100) compared to that of the BPF 500.

As described above, the BPF 10 according to the present disclosure is formed using the resonator 1 that contains a metamaterial structure, whereby resonance frequency of each mode can be reduced compared to the BPF 500 which uses the resonator 50 that does not contain a metamaterial structure. Therefore, the BPF 10 according to the present disclosure can achieve a passband equivalent to that of the BPF 500 with a size smaller than that of the BPF 500.

While a case in which the BPF 10 is formed using a plurality of resonators 1 has been described in this example embodiment, this is merely one example, and the BPF 10 may be formed using a plurality of resonators 2 or a plurality of resonators 3.

### Fifth Example Embodiment

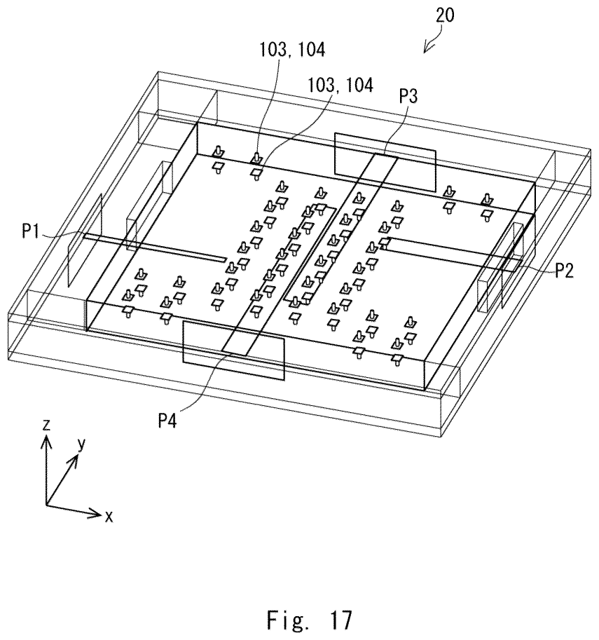

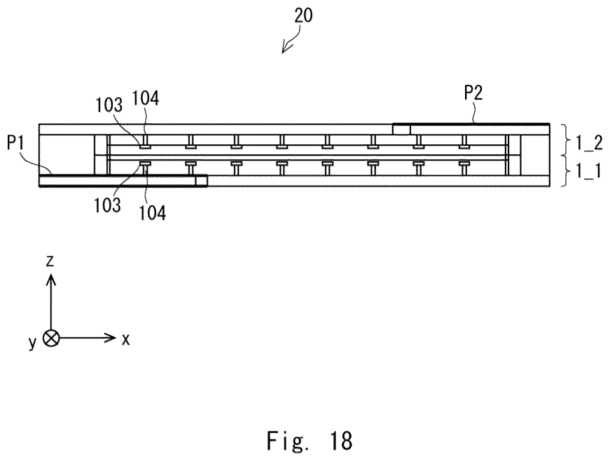

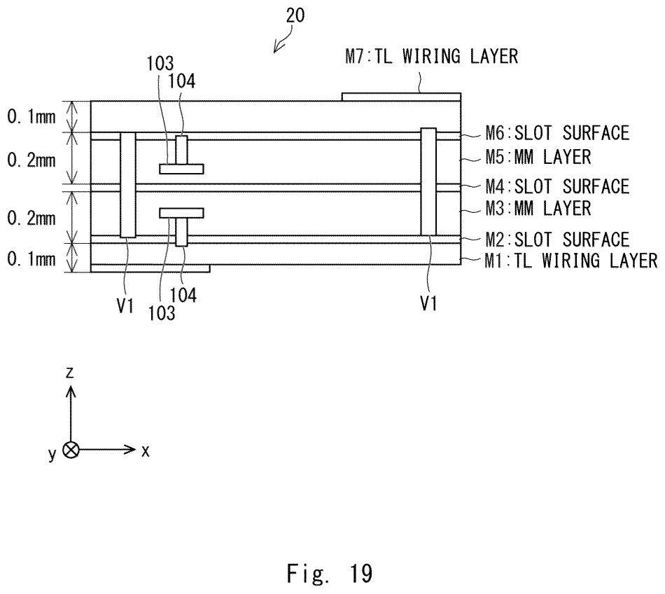

FIG. 17 is a schematic perspective view showing a configuration example of a second BPF according to the present disclosure. FIG. 18 is a schematic cross-sectional view showing a configuration example of the second BPF according to the present disclosure. FIG. 19 is a schematic cross-sectional view in which a part of the second BPF according to the present disclosure is enlarged.

As shown in FIGS. 17-19, a BPF 20 according to the present disclosure includes two resonators 1 (hereinafter these resonators 1 will also be referred to as resonators 1_1 and 1_2) laminated on a substrate. Specifically, one resonator 1_1 is provided in the substrate and the other resonator 1_2 is laminated on one resonator 1_1. In the examples shown in FIGS. 17-19, two resonators 1_1 and 1_2 are arranged in such a way that they are opposed to each other.

Further, one pair of input and output ports P1 and P2 is provided in two of the four sides of the rectangular BPF 20 opposed to each other, and another pair of input and output ports P3 and P4 is provided in the other two sides opposed to each other. These pairs of ports enable independent transmission with high isolation between high-frequency signals of two orthogonal polarization waves. Specifically, these two pairs of ports excite two electromagnetic field modes orthogonal to each other, whereby the aforementioned isolation can be kept high.

In a BPF in which a resonator that does not contain a metamaterial structure is used (hereinafter this BPF will also be referred to as a BPF 600), a high-order mode such as a TE210/TE120 mode is used, which makes the size larger. On the other hand, the BPF 20 according to the present disclosure is formed using the resonator 1 that contains a metamaterial structure, which allows the resonance frequency to be reduced, thus enabling a reduction in size.

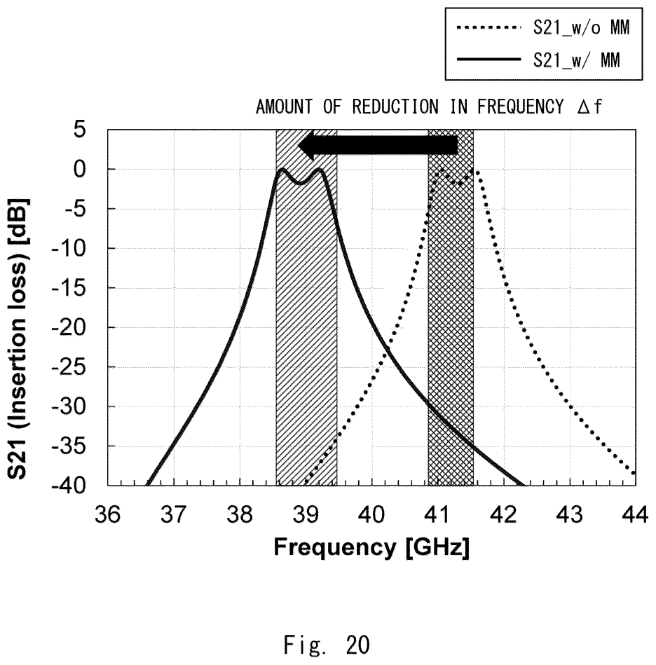

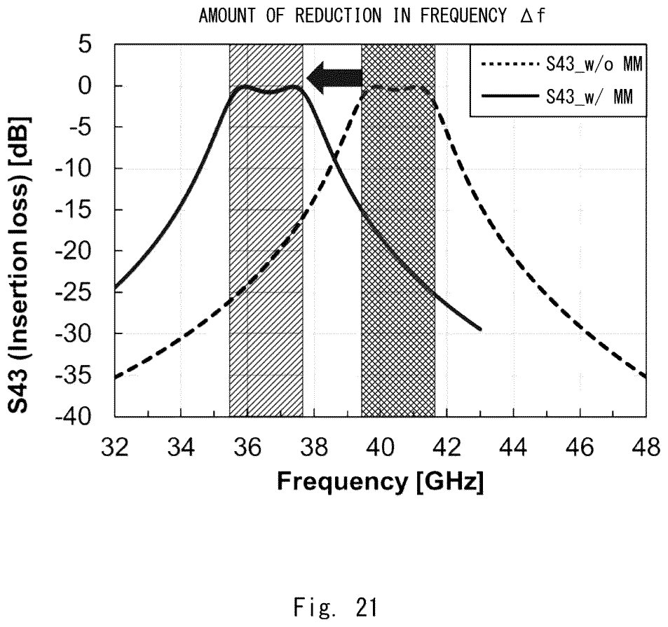

FIG. 20 shows results of an electromagnetic field simulation of transmission characteristics between the ports P2 and P1 of the second BPF according to the present disclosure. FIG. 21 shows results of an electromagnetic field simulation of transmission characteristics between the ports P4 and P3 of the second BPF according to the present disclosure. Note that FIGS. 20 and 21 show not only results of an electromagnetic field simulation of transmission characteristics of the BPF 20 according to the present disclosure but also results of an electromagnetic field simulation of transmission characteristics of the BPF 600 according to the comparative example in which a resonator that does not contain a metamaterial structure is used.

First, as shown in FIG. 20, while the central frequency of the passband of the BPF 600 according to the comparative example is 41.5 GHz in the pair of the ports P1 and P2, the central frequency of the passband of the BPF 20 according to the present disclosure is reduced to 39 GHz. Further, as shown in FIG. 21, while the central frequency of the passband of the BPF 600 according to the comparative example is 40.5 GHz in the pair of ports P3 and P4, the central frequency of the passband of the BPF 20 according to the present disclosure is reduced to 36.5 GHZ. Therefore, the BPF 20 according to the present disclosure can achieve a passband the same as that of the BPF 600 according to the comparative example with a size smaller than that of the BPF according to the comparative example to the extent of a percentage of the change in the frequency.

Further, in the BPF 20 according to the present disclosure, two signals share one housing composed of a pair of two resonators 1. Therefore, it is possible to mount the BPF 20 in a narrow space, such as a part immediately below a dual-polarized antenna array.

In the BPF 20 according to the present disclosure, patches 103 and vias 104 provided near the electromagnetic coupling unit of the slot opening or near the input/output terminals may be thinned out. Accordingly, the BPF 20 according to the present disclosure may be able to adjust resonator characteristics and electromagnetic coupling characteristics, whereby it may be possible to prevent circuit characteristics from being degraded.

Further, while a case in which the BPF 20 is composed of a plurality of resonators 1 has been described in this example embodiment, this is merely one example. For example, the BPF 20 may be formed using a plurality of resonators 2 or a plurality of resonators 3. Further, the example in which the BPF 20 includes one resonator 1 arranged in the substrate and one resonator 1 laminated thereon has been described in this example embodiment. However, this is merely one example. For example, the BPF 20 may include two or more resonators 1 arranged adjacent to each other in the substrate and two or more resonators 1 laminated thereon.

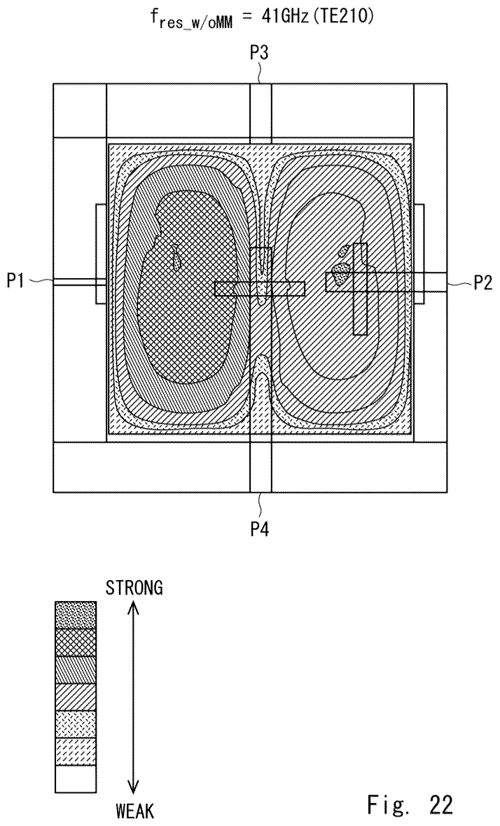

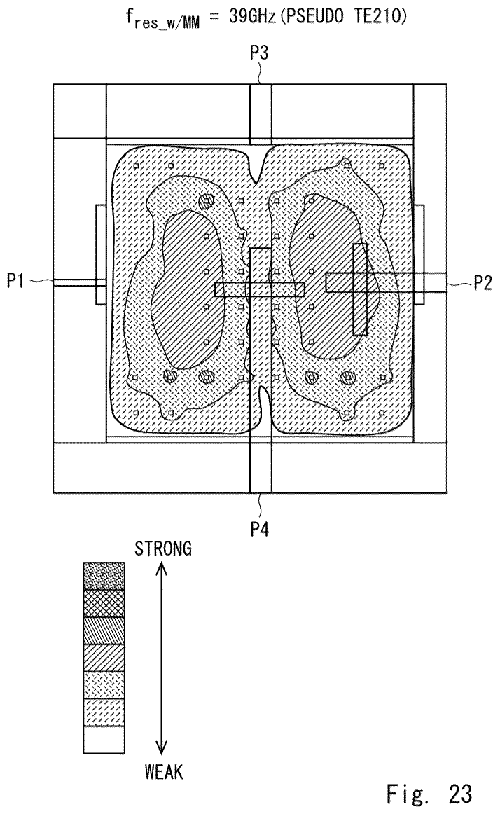

FIG. 22 shows results of an electromagnetic field simulation of electric field intensities at time of input and output in the ports P2 and P1 of the BPF 600 according to the comparative example. On the other hand, FIG. 23 shows results of an electromagnetic field simulation of electric field intensities at time of input and output in the ports P2 and P1 of the second BPF according to the present disclosure.

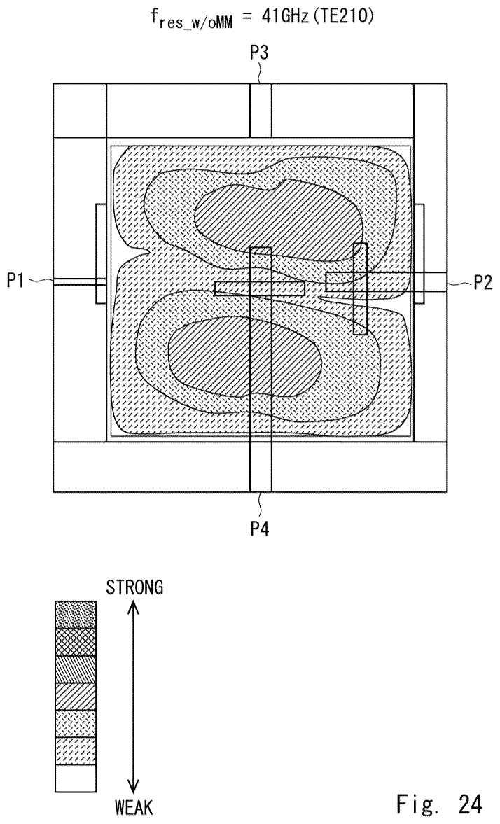

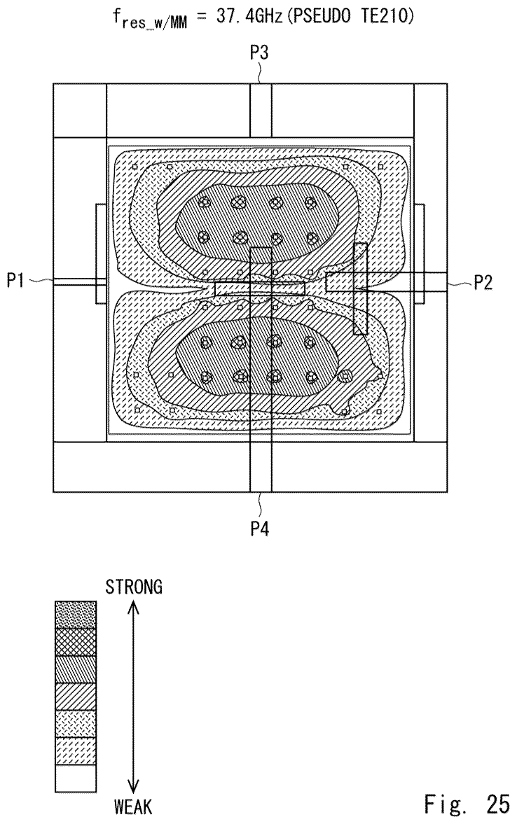

FIG. 24 shows results of an electromagnetic field simulation of electric field intensities at time of input and output in the ports P4 and P3 of the BPF 600 according to the comparative example. On the other hand, FIG. 25 shows results of an electromagnetic field simulation of electric field intensities at time of input and output in the ports P4 and P3 of the second BPF according to the present disclosure.

As can be seen from the comparison between FIG. 22 and FIG. 23 and the comparison between FIG. 24 and FIG. 25, in the BPF 20 according to the present disclosure, it is possible to effectively excite a pseudo TE210/TE120 (Pseudo-TE210/TE120) mode having effects similar to those of the TE210/TE120 mode in a lower frequency compared to that in the BPF 600 according to the comparative example.

### Sixth Example Embodiment

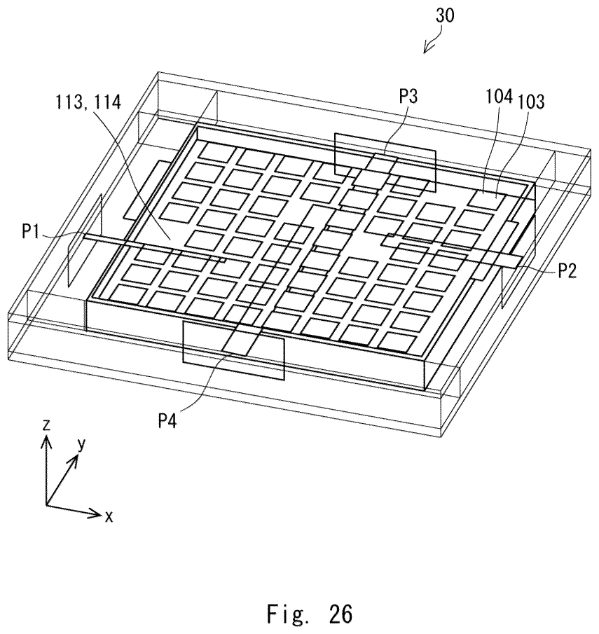

FIG. 26 is a schematic perspective view showing a configuration example of a third BPF according to the present disclosure. As shown in FIG. 26, a BPF 30 according to the present disclosure is different from the BPF 20 shown in FIG. 17 in that the size a of each patch 103 is made larger and a radius R of each via 104 is made smaller in the BPF 30 according to the present disclosure. Further, in the BPF 30 according to the present disclosure, some pairs of patches 103 and vias 104 are thinned out. Specifically, four out of 64 pairs of patches 103 and vias 104 of 8 rows×8 columns per resonator are randomly thinned out.

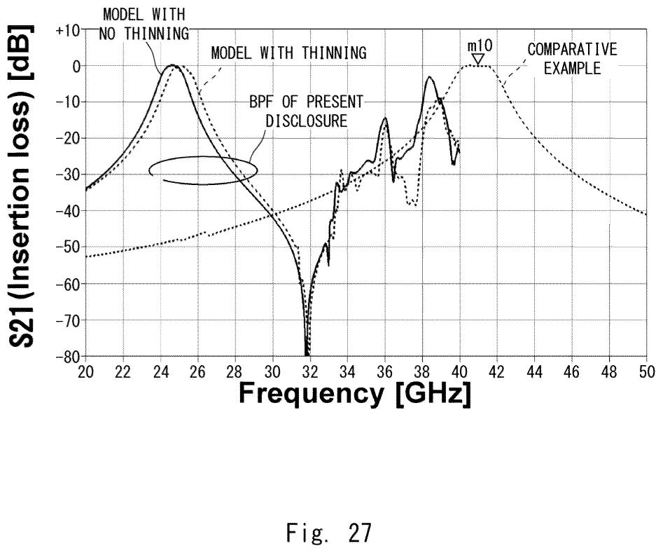

FIG. 27 shows results of an electromagnetic field simulation of transmission characteristics between ports P2 and P1 of the third BPF according to the present disclosure. Note that FIG. 27 shows not only results of a simulation of the BPF 30 in which patches and vias are thinned out but also results of a simulation of the BPF 20 in which neither patches nor vias are thinned out and results of a simulation of the BPF 600 according to the comparative example.

As shown in FIG. 27, in the BPF 30 in which patches and vias are thinned out, the effect of reducing the frequency is slightly reduced due to a decrease in a filling rate of a metamaterial structure compared to that in the BPF 20 in which neither patches nor vias are thinned out. However, in the BPF 30 in which patches and vias are thinned out, sufficiently high frequency reduction effects are achieved compared to those in the BPF 600 according to the comparative example. Specifically, the central frequency of the passband of the BPF 600 according to the comparative example is 40.5 GHZ, whereas the central frequency of the passband of the BPF 30 according to the present disclosure is reduced to about 24.5 GHZ. Therefore, the BPF 30 according to the present disclosure can achieve a passband the same as that of the BPF 600 according to the comparative example with a size smaller than that of the BPF 600 to the extent of a percentage of the change in the frequency. Specifically, the size of the BPF 30 can be ideally reduced to about 60% (=24.5/40.5×100) compared to that of the BPF 600.

Note that arbitrary number of patches 103 and vias 104 may be thinned out in the BPF 30 according to the present disclosure. Accordingly, the BPF 30 according to the present disclosure may adjust resonator characteristics and electromagnetic coupling characteristics, whereby it may be possible to prevent circuit characteristics from being degraded.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each embodiment can be appropriately combined with at least one of embodiments.

While the case in which the resonator according to the present disclosure is applied to a bandpass filter has been described in the above-described example embodiments, this is merely one example. For example, the resonator according to the present disclosure can be applied to various kinds of waveguide circuits other than a bandpass filter as a resonator of a duplexer, a slot antenna, or the like.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Further, the whole or part of the example embodiments disclosed above can be described as, but not limited to, the following supplementary notes.

### (Supplementary Note 1)

A resonator comprising:
a dielectric;
conductor plates provided so as to enclose the dielectric; and
a plurality of flat and conductive patches arranged inside the dielectric along a bottom surface of the conductor plates.

### (Supplementary Note 2)

The resonator according to Supplementary Note 1, wherein the plurality of patches are each formed in such a way that they have a size one tenth of or smaller than a wavelength corresponding to a resonance frequency.

### (Supplementary Note 3)

The resonator according to Supplementary Note 1, wherein the plurality of patches are arranged in a matrix along the bottom surface of the conductor plates.

### (Supplementary Note 4)

The resonator according to Supplementary Note 1, wherein the plurality of patches are arranged in a matrix along the bottom surface of the conductor plates in a state in which the plurality of patches are partially thinned out.

### (Supplementary Note 5)

The resonator according to Supplementary Note 1, further comprising a plurality of vias of conductors that extend from the bottom surface of the conductor plates to the plurality of patches.

### (Supplementary Note 6)

The resonator according to Supplementary Note 1, wherein
the plurality of patches comprise:
a plurality of first patches arranged in a matrix along the bottom surface of the conductor plates; and
a plurality of second patches laminated on the plurality of first patches.

### (Supplementary Note 7)

The resonator according to Supplementary Note 1, wherein
the plurality of patches comprise:
a plurality of first patches arranged in a matrix along the bottom surface of the conductor plates in such a way that the plurality of first patches are partially thinned out; and
a plurality of second patches laminated on the plurality of first patches and arranged in a matrix in a state in which the plurality of second patches are partially thinned out.

### (Supplementary Note 8)

A waveguide circuit comprising a plurality of resonators according to Supplementary Note 1.

### (Supplementary Note 9)

The waveguide circuit according to Supplementary Note 8, wherein the plurality of resonators are arranged adjacent to each other in a substrate.

### (Supplementary Note 10)

The waveguide circuit according to Supplementary Note 8, wherein
the plurality of resonators comprise:
one or more first resonators arranged in a substrate; and
one or more second resonators laminated on the one or more first resonators.

### (Supplementary Note 11)

The resonator according to Supplementary Note 1, wherein
the plurality of patches each have a rectangular planar shape, and
the plurality of patches are formed in such a way that a long side thereof becomes one tenth or less of a wavelength corresponding to a resonance frequency.

### (Supplementary Note 12)

The resonator according to Supplementary Note 1, wherein the conductor plates form one of a cuboid, cylindrical, or polygonal columnar shape.

### (Supplementary Note 13)

The resonator according to Supplementary Note 1, wherein
the resonator is provided in a substrate, and
the conductor plates are composed of the substrate and a plurality of vias formed in the substrate.

### (Supplementary Note 14)

The resonator according to Supplementary Note 1, further comprising a plurality of switches each provided between the plurality of patches.

### (Supplementary Note 15)

The waveguide circuit according to Supplementary Note 10, comprising:
a pair of a first input port and a first output port; and
a pair of a second input port and a second output port that cross the pair of the first input port and the first output port.

According to one example embodiment, it is possible to provide a resonator capable of achieving reduction in size and a waveguide circuit including the same.

What is claimed is:

1. A resonator comprising:
a dielectric;
conductor plates provided so as to enclose the dielectric; and
a plurality of flat and conductive patches arranged inside the dielectric along a bottom surface of the conductor plates.

2. The resonator according to claim 1, wherein the plurality of patches are each formed in such a way that they have a size one tenth of or smaller than a wavelength corresponding to a resonance frequency.

3. The resonator according to claim 1, wherein the plurality of patches are arranged in a matrix along the bottom surface of the conductor plates.

4. The resonator according to claim 1, wherein the plurality of patches are arranged in a matrix along the bottom surface of the conductor plates in a state in which the plurality of patches are partially thinned out.

5. The resonator according to claim 1, further comprising a plurality of vias of conductors that extend from the bottom surface of the conductor plates to the plurality of patches.

6. The resonator according to claim 1, wherein
the plurality of patches comprise:
a plurality of first patches arranged in a matrix along the bottom surface of the conductor plates; and
a plurality of second patches laminated on the plurality of first patches.

7. The resonator according to claim 1, wherein
the plurality of patches comprise:
a plurality of first patches arranged in a matrix along the bottom surface of the conductor plates in such a way that the plurality of first patches are partially thinned out; and
a plurality of second patches laminated on the plurality of first patches and arranged in a matrix in a state in which the plurality of second patches are partially thinned out.

8. A waveguide circuit comprising a plurality of resonators according to claim 1.

9. The waveguide circuit according to claim 8, wherein the plurality of resonators are arranged adjacent to each other in a substrate.

10. The waveguide circuit according to claim 8, wherein
the plurality of resonators comprise:
one or more first resonators arranged in a substrate; and
one or more second resonators laminated on the one or more first resonators.

11. The resonator according to claim 1, wherein
the plurality of patches each have a rectangular planar shape, and
the plurality of patches are formed in such a way that a long side thereof becomes one tenth or less of a wavelength corresponding to a resonance frequency.

12. The resonator according to claim 1, wherein the conductor plates form one of a cuboid, cylindrical, or polygonal columnar shape.

13. The resonator according to claim 1, wherein
the resonator is provided in a substrate, and
the conductor plates are composed of the substrate and a plurality of vias formed in the substrate.

14. The resonator according to claim 1, further comprising a plurality of switches each provided between the plurality of patches.

15. The waveguide circuit according to claim 10, comprising:
a pair of a first input port and a first output port; and
a pair of a second input port and a second output port that cross the pair of the first input port and the first output port.
